(19) United States
(12) Patent Application Publication
(10) Pub. No.: US 2006/0099356 A1
(43) Pub. Date: May 11, 2006

(54) Decorative laminated safety glass

(76) Inventor: Eric T. Pray, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/269,420

(22) Filed: Nov. 8, 2005

Related U.S. Application Data
(60) Provisional application No. 60/625,853, filed on Nov. 8, 2004.

(51) Int. Cl. B41M 5/40

(52) U.S. Cl. 428/32.34

(57) ABSTRACT

The present invention is a decorative laminated article comprising an image bearing thermoplastic interlayer wherein the image has been printed on the interlayer using an ink jet printing process, wherein the image comprises a white pigment on the surface of the thermoplastic interlayer. The present invention is also a process for ink-jet printing white pigment ink on a thermoplastic polymer to obtain an image bearing laminate with good adhesive qualities.

This application claims the benefit of U.S. Application No. 60/625,853, filed Nov. 8, 2004.

### BACKGROUND OF THE INVENTION

The present invention relates to decorative laminates bearing images printed on an interlayer by a process of ink jet printing. The present invention particularly relates to decorative laminates wherein the image has been printed onto an interlayer comprising polyvinyl butyral (PVB). The present invention also relates to ink formulations that are useful for preparing the laminates of the present invention.

Decorative laminates are known and obtained by various processes. DE 29706880, U.S. Pat. No. 4,968,553, U.S. Pat. No. 5,914,178, EP 1129844A1, and DE 20100717 disclose making decorative glass laminates via a silk screening process. Silk-screening an image onto an interlayer is a very time-consuming and expensive process for making decorative laminated safety glass. A process for making decorative glass laminates has also been described in U.S. Pat. No. 4,173,672. This patent describes a transfer lamination process wherein an image printed on paper is transferred to a thermoplastic film, and the film bearing the transferred image is then laminated between glass sheets.

Use of “ink jet” technology to print on PVB and polyurethanes for laminated safety glass has been disclosed in WO0218154. Ink jet printing is known and is a conventional process for printing wherein ink droplets are propelled through a printing head at a high speed towards a printing substrate. Ink jet technology is very flexible because any digital image can be printed onto a substrate.

However, one disadvantage of printing directly on PVB using an ink jet printing process is that PVB interlayers have a roughened surface pattern (Rz from 30-60 μm) that can cause poor image quality in a printed image. The roughened surface pattern is necessary in a PVB lamination process to obtain laminates free of air bubbles and other defects caused by the presence of trapped air during the lamination process. However, when ink jet printing onto PVB, the rough surface pattern can affect image quality with respect to mottle and resolution.

Other problems with conventional processes for ink-jet printing are encountered due to the inks used in conventional ink-jet processes. Low viscosity inks are required in a conventional ink jet printing process to alleviate high pressure build-up in the print head of the ink jet printer, and subsequent damage to the head and/or poor quality in the printed image. Ink jet printing is carried out conventionally by either (a) drop on demand (DOD) processes, such as a piezo electric printing or thermal ink jet printing processes, or (b) continuous drop ink jet printing. There are other factors as well that make low viscosity inks necessary and preferable in ink jet printing processes. However, use of conventional inks that are suitable for ink jet printing can result in poor image quality on a thermoplastic interlayer. Poor image quality can be the result when a low viscosity ink is sprayed onto a roughened surface such as a PVB surface that has been prepared for lamination, due to ink running from high points to low spots on the interlayer surface.

Another potential problem with printing an image on an interlayer prior to lamination onto another substrate is that the adhesive bond between the interlayer and the substrate can be significantly weakened due to colorant on the surface of the interlayer that can reduce the “effective” bonding surface area between the substrate and the interlayer. By “effective bonding surface” it is meant to describe that surface area where the interlayer and the substrate are in direct contact with each other without an intervening colorant layer. Reduction of the adhesive force of the laminate can result in the laminate having poor performance as a safety glass, or in the application for which it was intended.

Still further problems can be encountered with ink jet printing onto thermoplastic polymer interlayer when the printed image requires both white and clear (that is, areas where there is no ink jetted onto the substrate) portions. Current practice by the Applicants requires printing colored ink onto a white thermoplastic sheet, wherein incorporating an additive into the sheet itself produces the white pigmentation, and not printing on those areas that are to show white in the printed image. This is not a practical solution when a clear (transparent) area is desirable together in the same image with a portion of white.

In addition, ink jet printing a white pigment is not a known process. Conventionally no white ink system is known that is suitable for ink jet printing onto an interlayer material. This can be for various reasons, but one problem with ink-jet printing white inks can be the particle size of the white pigment used in the ink dispersion. In the practice of the present invention, printing on a thermoplastic polymer substrate requires use of a special system that will disperse the pigments, in addition to dispersing binders and stabilizers that stabilize the pigment and help it bind to the polymer substrate and produce an image-bearing laminate with acceptable adhesion.

It can be desirable in a process for printing on thermoplastic interlayers prior to lamination, to have a process for ink jet printing white ink onto thermoplastic interlayers so that areas of white can be observed in an image or text, in addition to clear or transparent areas where no ink has been printed onto the substrate.

It can be particularly desirable to have such a process and maintain laminate strength and resilience against breakage, while at the same time producing a quality image on the interlayer substrate.

### SUMMARY OF THE INVENTION

In one aspect, the present invention is a process for ink-jet printing white pigment ink onto a thermoplastic polymer substrate material, wherein the white pigment ink is a non-aqueous dispersion comprising white pigment particles of a suitable particle size, at least one organic solvent, and at least one dispersant for the white pigment.

In another aspect, the present invention is a non-aqueous white pigment ink dispersion suitable for ink-jet printing onto a thermoplastic polymer substrate material, wherein the dispersion comprises white pigment particles of a suitable particle size, at least one organic solvent, and at least one dispersant for the white pigment.

In still another aspect, the present invention is a laminate article comprising an image-bearing interlayer substrate, wherein the image was printed on the substrate by a process comprising the step of ink-jet printing a white ink dispersion onto at least one surface of the substrate.

In still another aspect, the present invention is a process for obtaining an image-bearing laminate having a laminate adhesive strength of at least about 1000 psi, the process comprising the steps: ink-jet printing a non-aqueous white pigmented ink onto at least one surface of a thermoplastic interlayer; and laminating the image-bearing interlayer between two transparent sheets of a suitable lamination substrate, wherein the white pigmented ink comprises white pigment particles of a suitable particle size, at least one organic solvent, and at least one dispersant for the white pigment.

In still another aspect, the present invention is a process for selectively increasing the opacity, or reducing the transmission, of an ink-jet printed image on a transparent substrate comprising the step of mixing white ink with colored ink in an ink-jet printing process.

### DETAILED DESCRIPTION OF THE INVENTION

In one embodiment, the present invention is a method for printing an image onto a thermoplastic interlayer material by an ink jet printing process. A suitable thermoplastic interlayer material for the purposes of the present invention can be any conventionally known or commercially available thermoplastic material which is flexible enough yet rigid enough to be passed through an ink jet printer. Suitable thermoplastic materials useful as printing substrates in the practice of the present invention include polyurethane (PUR), polyesters such as polyethylene terephtalate (PET), polyvinyl chloride (PVC), and polyvinyl butyral (PVB), polyolefins such as polyethylene and/or polypropylene, for example. Preferred for the purposes of the present invention is polyvinylbutyral (PVB). PVB is available commercially from E.I. DuPont de Nemours & Co., under the tradename of Butacite®, for example.

Ink jet printing onto an interlayer material of the present invention is preferably conducted using pigmented ink. Pigmented inks are preferred because of their color-fastness, thermal stability, edge definition, and low diffusivity on the printed substrate. In conventional practice, the pigment is suspended in a liquid medium that is conventionally referred to as the “vehicle”. Pigments suitable for use in the practice of the present invention can be dispersed in a non-aqueous vehicle. A “non-aqueous” vehicle suitable for use herein can include water in some minor proportion (no greater than 16 wt %) when particular organic solvents are used. Preferably the non-aqueous dispersion (that is, the dispersion obtained when pigment is suspended or dispersed in a non-aqueous vehicle) has less than about 14 wt % water, more preferably less than about 12 wt % water, and most preferably less than about 10 wt % water. Various conventional solvents are known and can be used. Useful, but less preferred, solvents include, for example, methyl isobutyl ketone (MIBK), methyl ethyl ketone (MEK), butyrolactone, and cyclohexanone. Suitable solvents include propylene glycol ethers, propylene glycol ether acetates, and ethylene glycol butyl ethers. In a preferred embodiment, dipropylene glycol monomethyl ether acetate (DPMA) is the primary solvent used to disperse the pigmented ink. Mixtures of any of these solvents is contemplated, but mixtures of DPMA with glycol ethers can be preferred.

Inks, or the non-aqueous dispersions, of the present invention have a viscosity that is sufficiently low that they can be jetted though a printing head of an ink jet printer without the necessity of heating the print head in order to lower the viscosity of the ink. In the practice of the present invention, the ink viscosity is below about 30 centipoises (cps), as measured at 25° C. Preferably the ink viscosity is below about 20 cps at 25° C. More preferably the ink viscosity is below about 15 cps, and most preferably below about 12 cps at 25° C.

Without being held to theory, the Applicants believe that problems with image quality using ink jet printing systems can result because ink systems used for jet printing have a much lower viscosity than, for example, inks used in a silk screen printing process. The low viscosity ink can “run” by gravity into the valleys of a roughened PVB surface. The inks, therefore, can form puddles in the low areas on the surface of the PVB, and will not adhere uniformly to the high spots. Therefore, while low viscosity ink is preferred, the viscosity should not be so low that the image quality is poor in the laminate, or that misting occurs during the printing process. Preferably the ink has a viscosity greater than about 1 cps. For DOD printing processes, the ink preferably has a viscosity above about 1.5 cps, more preferably above about 1.7, and most preferably above about 1.8 cps measured at 25° C. Viscosities of the inks are determined according to DuPont Standard Test Methods.

Preferable inks for use in the practice of the present invention are those that provide printed images having a satisfactory combination of image quality, light fastness, and weatherability. Further, laminates that incorporate image-bearing interlayers of the present invention should have the adhesion properties described herein. Due to the nature of the polymeric interlayer substrates used herein for printing, and the requirements for adhesion in a safety glass, choice of a suitable ink is not problem free. Ink suitable for use in the practice of the present invention must also be compatible with the substrate to give satisfactory results.

Printing heads useful for piezo electric processes are available from, for example, Epson, Seiko-Epson, Spectra, XAAR and XAAR-Hitachi. Printing heads useful for thermal ink jet printing are available from, for example, Hewlitt-Packard and Canon. Printing heads suitable for continuous drop printing are available from Iris and Video Jet, for example.

Traditionally, pigments are stabilized to dispersion in a vehicle by dispersing agents, such as polymeric dispersants or surfactants. More recently, so-called “self-dispersible” or “self-dispersing” pigments (hereafter “SDPs”) have been developed that are suitable for use in the practice of the present invention. SDPs are dispersible in an aqueous vehicle without the use of traditional dispersants. The pigment particles of this invention may be stabilized according to several methods. The pigment particles can be made self-dispersing by a surface treatment as described in, for example, WO01/94476, herein incorporated by reference for all purposes as if fully set forth, or the pigment particles can be stabilized by treatment with dispersant in the traditional way, or the pigments can be dispersed by some combination of surface treatment and traditional treatment.

Preferably, when a traditional dispersant is employed, the dispersant can be a random or structured polymeric dispersant. Preferred random polymers include acrylic polymer and styrene-acrylic polymers. Most preferred, however, are structured dispersants that include AB, BAB and ABC block copolymers, branched polymers and graft polymers. Some useful structured polymers are disclosed in U.S. Pat. No. 5,085,698, EP-A-0556649 and U.S. Pat. No. 5,231,131, which are incorporated herein by reference for all purposes as if fully set forth. Commercially available dispersants such as Dispersbyk® 2000 and Dispersbyk® 2001 can be used, for example.

An important parameter in the practice of the present invention is the Frequency of the roughened interlayer surface onto which is to be printed an image. The Frequency of the roughened surface can be calculated using data obtained from profilometer data. In the practice of the present invention, a suitable Frequency is above about 0.60 cycles/mm. It is preferable that the Frequency be in the range of from about 0.60 cycles/mm to about 3 cycles/mm. More preferably, the Frequency is in the range of from about 0.75 to about 2.9, and most preferably the Frequency is in the range of from about 0.85 to about 2.5 cycles/mm. Above the upper limit significant improvement in the image quality may not be observed. Below the lower limit, the image quality may be poor.

In another embodiment, the invention is a laminate comprising an image-bearing thermoplastic interlayer of the present invention. The interlayer can be laminated together with various transparent substrates such as, for example, glass or polycarbonate. Preferably, the image-bearing interlayer sheet is laminated between at least two sheets of glass. Other layers of interlayer can be positioned between the image-bearing interlayer and the glass, for example as in a glass/“conventional PVB”/“printed PVB”/glass laminate, wherein the printed PVB surface is in contact with the conventional PVB interlayer surface. The image-bearing interlayer can also be laminated directly to the glass. Conventional laminating techniques are useful and effective in obtaining laminates of the present invention.

In any event, a laminate of the present invention has adhesive strength that is comparable to conventional or non-decorative laminates. Adhesion in a laminate of the present invention, as measured by a compressive shear test is at least 1000 psi. Preferably the compressive shear strength is from about 1400 to about 2600 psi. More preferably, the adhesion of a laminate of the present invention is in the range of from about 1450 psi to about 2575 psi, and even more preferably from about 1740 to about 2540 psi. Most preferably the laminate has an adhesive strength of from about 1800 psi to about 2520 psi. Laminates of the present invention can be used in any application wherein conventional (that is, non-decorative) laminated glass is used. In addition to the conventional uses as safety glass, however, the laminates of the present invention can be used as decorative articles such as picture windows, decorative countertops, graphic art, image-bearing store-front windows, displays bearing company logos, advertising media, and/or any other use wherein a transparent laminate bearing an image can be desirable. In the practice of the present invention, and image can be defined as any visually discernible pattern which is can be digitized and ink-jet printed onto a substrate such as, for example, a drawing, a photograph, text, graphical design, patterns of colors, symbols, and/or similar examples.

Laminates of the present invention can be obtained from the image-bearing interlayer and known materials useful for producing safety glass or windows, such as glass or polycarbonate, for example. Lamination of the interlayer to the other components can be accomplished using conventional lamination techniques. For example, an image-bearing interlayer can be laminated to glass by pressing the interlayer between two sheets of glass at an elevated temperature and pressure, under conditions by which air bubbles can be removed or prevented from being trapped in the laminate article.

In another embodiment, the present invention is an image-bearing interlayer sheet that has been printed on according to the process described herein. A printed interlayer sheet of the present invention can be laminated with other suitable interlayer materials, such as PET, PUR and/or PVB, to obtain a stacked interlayer that can in turn be laminated with a suitable substrate of the present invention, such as glass or polycarbonate for example.

In another embodiment of this invention, a second interlayer sheet is placed between the primary image carrying layer and the laminate substrate, wherein the second layer can carry a printed image or be any solid, translucent color such as red, green, blue, or white, for example.

The white pigment ink of the present invention can be any dispersible white pigment that can be milled to a particle size sufficiently small to be ink jet printed using an ink jet printing device, typically a suitable white pigment particle has a size in the range of from about 200 nm to about 300 nm. Preferably the white pigment particle has a size in the range of from about 210 to about 290 nm, and more preferably in the range of from about 210 to about 280 nm. Most preferably, the white pigment particle has a size in the range of from about 220 to about 280 nm.

In a preferred embodiment, titanium dioxide can be used if it is sufficiently milled and then dispersed in a vehicle that provides a stable white pigment ink for ink jet printing.

In another preferred embodiment of the present invention, dry titanium dioxide powder can be dispersed directly into an ink vehicle without the addition of water to the ink system. Noting that particle size can have an effect on ink viscosity, using the teachings provided herein one of ordinary skill in the art can find a proper compositional balance to obtain a non-aqueous dispersion suitable for the uses described herein or in the related art.

Preferably a suitable amount of white pigment is dispersed into the vehicle to provide sufficient pigment on a substrate surface when during the ink jet printing process. If the pigment level is too low, the depth of the coverage will not be sufficient to cover the substrate, and the substrate may show through the pigment on the substrate surface. If the pigment concentration is too high, the viscosity of the ink may be too high too use in an ink jet printing process. Preferably the pigment is dispersed in an amount of from about 1 part per hundred parts (pph) to about 40 pph. More preferably the pigment is dispersed in an amount of from about 5 pph to about 35 pph, even more preferably in an amount of from about 10 pph to about 30 pph.

In another embodiment, white ink can be mixed with other inks to provide selective areas where the opacity of the ink-jet printed image is increased.

### EXAMPLES

The following examples are presented to illustrate the invention. The examples are not intended to limit the scope of the invention in any manner.

Test Methods

Surface Roughness, Rz, is determined from the 10 point average roughness as described in ISO-R468 and is expressed in microns. Surface roughness is measured using a Mahr Federal (Providence, R.I.) surfanalyzer. Surface Pattern Frequency is calculated from the surfanalyzer data by making a graph of the autocorrelation function vs. distance of the profilometer data. The autocorrelation data are analyzed by fast Fourier transforms. The reported frequency of the surface pattern is the median frequency.

Compressive Shear Adhesion Test: Laminate adhesion (given in terms of compressive shear strength) is determined by the compressive shear test. The compressive shear strength is determined by sawing a laminate into six 2.54 cm×2.54 cm chips. The chips are held in a jig at 45° and a compression testing instrument is used to place force on the chip at the rate of 0.25 cm/min. The amount of force to cause cohesive failure of the glass-PVB bond is the compressive shear strength of the laminate.

General Ink Preparation Method

A 100 gram sample of the ink is prepared as follows:

To a 250-ml bottle charge the solvent(s) and the dispersant(s), and mix the components until the dispersants dissolve completely in the solvent(s). White pigment is added slowly to the container and mixed well. To the mixture is added zirconium media (0.8-1.0 mil). Into the container is then added a roller mill and the speed of the mill is adjusted to 35 rpm. The ink is milled for a specified time. The ink is separated from the media by filtration using 1-micron filter paper. The ink is then analyzed for physical properties. The solvents (ink vehicles) are abbreviated below as follows: dipropylene glycol methyl ether (DPM); dipropylene glycol methyl ether acetate (DPMA); tripropylene glycol propyl ether (TPnP); dipropylene glycol propyl ether (DPnP); tripropylene glycol methyl ether (TPM).

### Examples 1 to 5

The inks were prepared according to the General Procedure, using the components in Table 1 in the amounts shown. The mixture in each example was milled for 12 hours. Examples 1, and 3-5 showed good filterability, and Example 2 had poor filterability. The inks had moderate to good stability, and each was excellent when tested for jetability, that is, excellent ability to be ink-jetted out of a printing head.

### Examples 6-13

The inks were prepared according to the General Procedure, using the components in Table 1 in the amounts shown. The mixture in each example was milled for 24 hours. Examples 6, and 8-13 showed good filterability, and Example 7 had poor filterability. The inks had moderate to good stability, and each had excellent jetability.

TABLE 1

| | Pigment | Ink Vehicle | Dispersant | Viscosity |
|---|---|---|---|---|
| Example | (pph) | (pph) | (pph) | (CPS) |
| 1 | R700 (25) | DPM (65) | D 2001 (10) | 7.05 |
| 2 | R700 (25) | DPM (65) | D 2000 (10) | 7.88 |
| 3 | R700 (25) | PPE | D 2001 (10) | 10.30 |
| | | (16.25)/DPM | | |
| | | (48.75) | | |
| 4 | TS-6200 | DPM (65) | D 2001 (10) | 6.83 |
| 5 | TS-6200 | DPM (65) | D 2001 (10) | 7.00 |
| 6 | R700 (25) | DPM (73) | D 2001 (2) | 4.88 |
| 7 | R700 (25) | DPMA (73) | D 2001 (2) | 4.53 |
| 8 | R700 (25) | TPnP (73) | D 2001 (2) | 9.20 |
| 9 | R700 (25) | DPnP (73) | D 2001 (2) | 5.53 |
| 10 | R700 (25) | DPnP (54.8)/ | D 2001 (2) | 4.52 |
| | | DPMA (18.3) | | |
| 11 | R700 (25) | DPM (58.5)/ | D 2001 (10) | 7.35 |
| | | TPM (6.5) | | |
| 12 | R700 (25) | DPM (58.5)/ | D 2001 (10) | 8.22 |
| | | PPH (6.5) | | |
| 13 | R700 (25) | DPM (65) | D 2001 (10) | 6.84 |

R700 is TiO₂ with and an alumina treatment, with 0.3% trimethylol propane (TMP), commercially available.
TS-6200 is TiO₂ with and an alumina treatment and a silica wet treatment, citric acid and TMP, commercially available.
D 2000 is Dispersbyk 2000.
D 2001 is Dispersbyk 2001.

### Examples 14 and 15 and Comparative Examples C1

The ink of Example 11 was printed onto a sheet of PVB at 100% coverage and also at 50% coverage, and the sheets laminated to glass. The adhesion was measured and is provided in Table 2.

### Examples 16 and 17 and Comparative Examples C2

The ink of Example 12 was printed onto a sheet of PVB at 100% coverage and also at 50% coverage, and the sheets laminated to glass. The adhesion was measured and is provided in Table 2.

### Examples 18 and 19 and Comparative Examples C3

The ink of Example 13 was printed onto a sheet of PVB at 100% coverage and also at 50% coverage, and the sheets laminated to glass. The adhesion was measured and is provided in Table 2.

TABLE 2

| | Coverage | |
|---|---|---|
| Example | (%) | Adhesion (psi) |
| 14 | 100 | 1440 |
| 15 | 50 | 2468 |
| C1 | 0 | 2355 |
| 16 | 100 | 1345 |
| 17 | 50 | 2340 |
| C2 | 0 | 2325 |
| 18 | 100 | 1491 |
| 19 | 50 | 2354 |
| C3 | 0 | 2397 |

What is claimed is:

1. A process for ink-jet printing white pigment ink onto a thermoplastic polymer substrate material, wherein the white pigment ink is a non-aqueous dispersion comprising white pigment particles of a suitable particle size for printing using an ink-jet printing device, at least one organic solvent, and at least one dispersant for the white pigment.

2. The process of claim 1 wherein the non-aqueous dispersion comprises less than about 15 wt % water.

3. The process of claim 2 wherein the non-aqueous dispersion comprises less than about 14 wt % water.

4. The process of claim 3 wherein the non-aqueous dispersion comprises less than about 12 wt % water.

5. The process of claim 4 wherein the non-aqueous dispersion comprises less than about 10 wt % water.

6. The process of claim 5 wherein the non-aqueous dispersion comprises a solvent selected from the group consisting of: methyl isobutyl ketone (MIBK); methyl ethyl ketone (MEK); butyrolactone; cyclohexanone; propylene glycol ethers; propylene glycol ether acetates; ethylene glycol butyl ethers; dipropylene glycol monomethyl ether acetate (DPMA); and/or mixtures thereof.

7. A non-aqueous white pigment ink dispersion suitable for ink-jet printing onto a thermoplastic polymer substrate material, wherein the dispersion comprises white pigment particles of a suitable particle size for ink-jet printing using an ink-jet printing device, at least one organic solvent, and at least one dispersant for the white pigment.

8. The dispersion of claim 7 wherein the non-aqueous dispersion comprises less than about 14 wt % water.

9. The dispersion of claim 8 wherein the non-aqueous dispersion comprises less than about 12 wt % water.

10. The dispersion of claim 9 wherein the non-aqueous dispersion comprises less than about 10 wt % water.

11. The dispersion of claim 10 wherein the non-aqueous dispersion comprises a solvent selected from the group consisting of: methyl isobutyl ketone (MIBK); methyl ethyl ketone (MEK); butyrolactone; cyclohexanone; propylene glycol ethers; propylene glycol ether acetates; ethylene glycol butyl ethers; dipropylene glycol monomethyl ether acetate (DPMA); and/or mixtures thereof.

12. The dispersion of claim 11 wherein the non-aqueous dispersion comprises a solvent selected from the group consisting of: propylene glycol ethers; propylene glycol ether acetates; ethylene glycol butyl ethers; dipropylene glycol monomethyl ether acetate (DPMA); and/or mixtures thereof.

13. The dispersion of claim 12 wherein the non-aqueous dispersion comprises dipropylene glycol monomethyl ether acetate (DPMA).

14. The dispersion of claim 7 wherein the dispersion has a viscosity of less than about 30 centipoises (cps), as measured at 25° C.

15. The dispersion of claim 14 wherein the dispersion has a viscosity of less than about 15 centipoises (cps), as measured at 25° C.

16. The dispersion of claim 15 wherein the dispersion has a viscosity of less than about 12 centipoises (cps), as measured at 25° C., but greater than about 1 cps.

17. A laminate article comprising an image-bearing interlayer substrate, wherein the image is printed on the substrate by a process comprising the step of ink-jet printing white ink dispersion onto at least one surface of the substrate.

18. The laminate article of claim 17 wherein the image-bearing interlayer is a thermoplastic polymer selected from the group consisting of: polyurethane (PUR); polyesters; polyvinyl chloride (PVC); polyvinyl butyral (PVB); and polyolefins.

19. The laminate article of claim 18 wherein the image-bearing interlayer is a thermoplastic polymer selected from the group consisting of: polyurethane (PUR); polyesters; and PVB.

20. The laminate of claim 19 wherein the laminate has an adhesive strength of at least about 1000 psi, and wherein the laminate is suitable for use as safety glazing.

21. A process for obtaining an image-bearing laminate having a laminate adhesive strength of at least about 1000 psi, the process comprising the steps: ink-jet printing a non-aqueous white pigmented ink onto at least one surface of a thermoplastic interlayer; and laminating the image-bearing interlayer between two transparent sheets of a suitable lamination substrate, wherein the white pigmented ink comprises white pigment particles having a size in the range of from about 200 to about 300 nm, at least one organic solvent, and at least one dispersant for the white pigment.
